(19) United States
(12) Patent Application Publication
(10) Pub. No.: US 2020/0244379 A1
(43) Pub. Date: Jul. 30, 2020

(54) DETERMINING TIME OFFSET IN AUDIO STREAMS

(71) Applicant: NXP B.V., Eindhoven (NL)

(72) Inventors: Daniel Johannes Sobe, Bischofswerda (DE); Matthias Schattka, Dresden (DE)

(21) Appl. No.: 16/262,719

(22) Filed: Jan. 30, 2019

(51) Int. Cl. H04H 20/10; H04H 40/18; H04H 60/40

(52) U.S. Cl. CPC H04H 20/106; H04H 60/82; H04H 60/40; H04H 40/18

(57) ABSTRACT

A radio receiver is disclosed. The radio receiver includes a plurality of receiving ports to receive identical audio streams, a history buffer and a controller for retrieving information from a first stream in the plurality of identical audio streams that is received first. the controller is configured to store the retrieved information in the history buffer and compare the stored information with an information about a second stream in the plurality of identical audio streams to determine a time offset between the first stream and the second stream.

### BACKGROUND

Modern broadcast receivers have to support multiple audio inputs from different broadcast domains, such as FM, Digital Audio Broadcast (DAB), or Internet radio. In case of a reception loss of one of the audio sources, modern receivers support the switching to an alternative reception source when they are available. To make such a switch seamless and not recognizable by the listener, the different audio sources need to be aligned and time offset be known.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a radio receiver is disclosed. The radio receiver includes a plurality of receiving ports to receive identical audio streams, a history buffer and a controller for retrieving information from a first stream in the plurality of identical audio streams that is received first. the controller is configured to store the retrieved information in the history buffer and compare the stored information with an information about a second stream in the plurality of identical audio streams to determine a time offset between the first stream and the second stream.

In some examples, a baseband processor is included to play one of the first stream and the second stream via a speaker. The controller is further configured to play the second stream starting from a point in time at which the first stream interrupts. The retrieved information includes blocks of data each containing a preselected width portion of the first stream. Each of the blocks of data including a start time timestamp and an end time timestamp of a section of the first stream.

In some embodiments, the preselected width is in a range 1 to 5 seconds. In some examples, the preselected width is automatically selected by the controller. In other examples, the preselected width is set through a changeable configuration for the controller.

In another embodiment, a method for determining a time offset between two identical audio streams is disclosed. The method includes receiving a plurality of identical audio streams, each being delayed with respect to other streams in the plurality of identical audio streams. The method further includes retrieving information from a first stream in the plurality of identical audio streams that is received first and storing the retrieved information in a history buffer and comparing the stored information with an information about a second stream in the plurality of identical audio streams to determine a time offset between the first stream and the second stream.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 shows a schematic diagram of a radio receiver;

FIG. 2 shows correlation of two audio streams having a time delay; and

FIG. 3 shows a method of correlating two audio streams having a time delay.

Note that figures are not drawn to scale. Intermediate steps between figure transitions have been omitted so as not to obfuscate the disclosure. Those intermediate steps are known to a person skilled in the art.

### DETAILED DESCRIPTION

Many well-known manufacturing steps, components, and connectors have been omitted or not described in details in the description so as not to obfuscate the present disclosure.

A radio may receive a same audio stream from different sources and in case of an interruption from one source, the radio can seamlessly switch to a stream from another source. However, streams received from different sources are not time synchronized due to different delays in the transmission channels. Therefore, the streams are correlated so that switching from one stream to another does not cause a break in audio playback and provides a good user experience.

The received audio streams are broken up into small blocks and the information about the blocks is stored in a history buffer. The limited amount of audio data is also stored. For example, last 10 seconds of audio stream may be stored in a memory. This time may be configurable depending on the size of the memory. The history buffer may include time stamps and audio stream data for the purpose of correlation. For example, pointers to the audio data stored in the memory may be included in the history buffer along with start and end time stamps of each block in the actual audio stream.

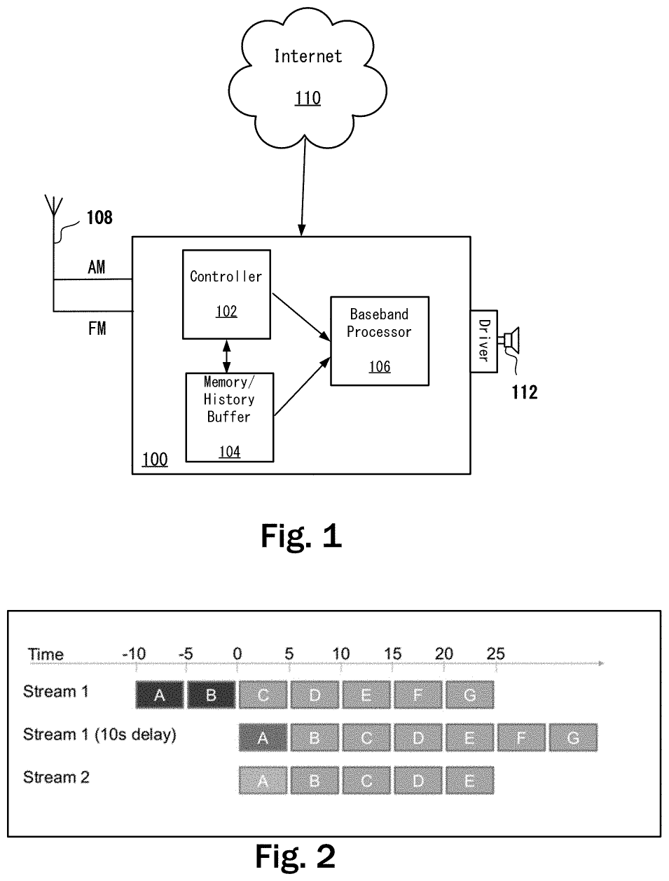

FIG. 1 shows a schematic diagram of a radio receiver 100. Only components that are relevant to the discussion here are being shows so as not to obfuscate the present disclosure. The radio receiver 100 includes an antenna 108 for receiving AM/FM audio streams. Digital radio stream may also be received using the same antenna. In some embodiments, the radio receiver 100 may include more than one antennas for receiving different types of audio streams as discussed here. The radio receiver 100 may also be connected to the Internet 110 to receive audio streams via the Internet transmission.

The radio receiver 100 includes a speaker 112 coupled to an audio driver to play a selected audio stream with the help of a baseband processor 106. The radio receiver 100 includes a controller 102 for receiving multiple identical audio streams through different channels and correlating the received audio streams and store the information about the plurality of audio streams in a memory and history buffer 104.

In some examples, the radio receiver 100 is configured to be aware of comparative delays in different types of reception channels. For example, a stream being received via the Internet may be slower than a stream being received on the FM band. When the radio receiver 100 is tuned to a particular program, the radio receiver 100 starts to play one stream and also starts to buffer the stream in the memory. A history buffer 104 is maintained with information about the data blocks of the audio streams.

FIG. 2 illustrates correlating of two audio streams, Stream 1 and Stream 2, in which Stream 2 is delayed by 10 seconds. When Stream 1 is received, the controller 102 start to store the last configurable amount of stream data (for example, the last 10 seconds of data pertaining to Stream 1). The stored data includes the portions of Stream 1. The controller 102 also breaks Stream 1 in blocks and stores the information about the blocks in a history buffer 104. The information stored in the history buffer 104 may include starting time stamp and ending time stamp for each block of data.

For illustration purposes, assuming Stream 1 starts at −10 second, the controller 102 starts to store blocks of 5 second of Stream 1 in the history buffer 104. Stream 2 starts to arrive at a 10 second delay. At that time, block C of Stream 1 is being received. Hence, for stream correlation purposes, instead of comparing the two streams at 0 second, the controller 102 starts to correlate Stream 2 with Stream 1 data in the history buffer 104. Stream 2 is also broken up into blocks of equal and same size as the blocks of Stream 1. The controller 102 compares the blocks of Stream 1 from the history buffer 104 starting at −10 seconds with the blocks of Stream 2. When a match is found, the delay in Stream 2 is known because the controller 102 is aware that when block A of Stream 1 was received and compares it the time when block A of Stream 2 was received.

In some examples, after correlation, the controller 102 maintains a linked list of correlated blocks of the two audio streams. When Stream 1 is playing and, for example, experiences and interruption at block number C, the controller 102 can look up the linked list to identify the corresponding block in Stream 2. The controller 102 may either start to play the corresponding block in Stream 2 from the start or may start to play that block from the same time location already known from the block of Stream 1 where the interruption occurred.

Once the delay or time offset between the two audio streams is known, if Stream 1 interrupts, the controller 102 can switch to a corresponding delayed portion of Stream 2. In some embodiments, last few seconds of audio, the length of time can be configurable, of both streams are stored in the memory 104. In some embodiments, the history buffer or the memory 104 may be a volatile memory.

In the example of FIG. 2, the time difference of the two audio streams is 10 seconds. To find the delay by cross correlation, Stream 2 can be captured at time index Os. For Stream 1, data from the history buffer 104 at time index −10s can be used, so capture of Stream 1 can start at the same time as Stream 2. Capture takes 5 seconds. The total time to have a buffer available for cross correlation computation is thus 5 seconds.

The embodiments described herein provides the results of a computation of the delay between two audio sources within a time frame that is comparable to the actual delay between the two streams. Typical solutions require substantially more time for such computation. Another advantage of the embodiments described herein improves scalability because the time required for the time offset computations do not increase with the delay between the audio streams.

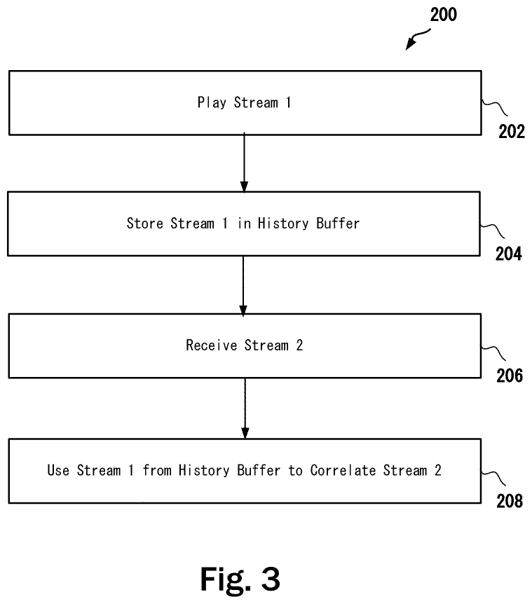

FIG. 3 depicts a method 200 for determining a time offset between two audio streams. Other than one stream being delayed, the two streams are identical. Accordingly, at step 202 the radio receiver 100 receives Stream 1 through a first communication channel. The radio receiver 100 may start playing Stream 1 via the speaker 112. At step 204, The radio receiver 100 also stores at least portions of Stream 1 in the history buffer 104. Stream 1 is broken up into blocks, each having a preselected equal length. For example, each block may represent five seconds of Stream 1. In another example, the radio receiver 100 may be configured to select a shorter time blocks depending on typical delays in received streams from different channels. Each block includes start and end time stamp of the audio stream in the block. At step 206, Stream 2 is received. Stream 2 is delayed by an unknown time. Typically, the delay may be in seconds between streams received via AM/FM channels and digital radio channel. Comparatively, the delay in streams received by AM/FM and the Internet is likely to be more. The radio receiver 100 may use historic data to determine typical delays in different channels and set the block size accordingly. It may be noted that since blocks are compared for the purpose of correlation, smaller blocks can be compared faster and it may result in a faster correlation and determination of the time offset. At step 208, the radio receiver 100 uses Stream 1 data from the history buffer 104 and compares blocks of Stream 1 and Stream 2 to determine the time offset between Stream 1 and Stream 2. The time offset is then stored in the memory 104 and can be used by the controller 102 or the baseband processor 106 to switch from one stream to another in case of an interruption in one stream.

Some or all of these embodiments may be combined, some may be omitted altogether, and additional process steps can be added while still achieving the products described herein. Thus, the subject matter described herein can be embodied in many different variations, and all such variations are contemplated to be within the scope of what is claimed.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A radio receiver, comprising:
a plurality of receiving ports configured to receive a plurality of identical audio streams;
a history buffer;
a controller configured to
retrieve information from a first stream in the plurality of identical audio streams that is received first,
store the retrieved information in the history buffer,
compare the stored information with an information about a second stream in the plurality of identical audio streams to determine a time offset between the first stream and the second stream, and
maintain a linked list of correlated blocks in the first stream and the second stream, wherein each pair of correlated blocks in the first stream and the second stream has identical content.

2. The radio receiver of claim 1, further comprising:
a baseband processor configured to play one of the first stream and the second stream via a speaker.

3. The radio receiver of claim 1, wherein the controller is further configured to play the second stream starting from a point in time at which the first stream interrupts.

4. The radio receiver of claim 1, wherein the retrieved information includes blocks of data, each block containing a preselected width portion of the first stream.

5. The radio receiver of claim 4, wherein each of the blocks of data includes a start time timestamp and an end time timestamp of a section of the first stream.

6. The radio receiver of claim 4, wherein the preselected width is in a range of 1 to 5 seconds.

7. The radio receiver of claim 6, wherein the controller is further configured to automatically select the preselected width.

8. The radio receiver of claim 6, wherein the preselected width is set through a changeable configuration for the controller.

9. A method for determining a time offset between two identical audio streams, the method comprising:
receiving a plurality of identical audio streams, each identical audio stream being delayed with respect to other streams in the plurality of identical audio streams;
retrieving information from a first stream in the plurality of identical audio streams that is received first and storing the retrieved information in a history buffer;
comparing the stored information with an information about a second stream in the plurality of identical audio streams to determine a time offset between the first stream and the second stream; and
maintaining a linked list of correlated blocks in the first stream and the second stream, wherein each pair of correlated blocks in the first stream and the second stream has identical content.

10. The method of claim 9, wherein the retrieved information includes blocks of data, each block containing a preselected width portion of the first stream.

11. The method of claim 10, wherein each of blocks of data includes a start time timestamp and an end time timestamp of a section of the first stream.

12. The method of claim 10, wherein the preselected width is in a range of 1 to 5 seconds.

13. The method of claim 12, further comprising:
automatically selecting the preselected width by the controller.

14. The method of claim 12, wherein the preselected width is set through a changeable configuration for the controller.
